(19) United States
(12) Patent Application Publication
(10) Pub. No.: US 2026/0274277 A1
(43) Pub. Date: Sep. 17, 2026

(54) DAMAGE PLACE PREDICTING DEVICE, DAMAGE PLACE PREDICTING METHOD, DAMAGE PLACE PREDICTING PROGRAM, AND TRAINED MODEL GENERATING METHOD

(71) Applicant: GEO SEARCH CO., LTD., Tokyo (JP)

(72) Inventors: Fumio Sei, Nagoya-shi, Aichi (JP); Takenao Kuno, Nagoya-Shi, Aichi (JP); Fuminori Sato, Nagoya-Shi, Aichi (JP); Hideaki Morita, Ota-ku, Tokyo (JP); Yukio Ozawa, Ota-ku, Tokyo (JP); Hiroyuki Yamane, Ota-ku, Tokyo (JP); Mariko Yamashita, Ota-ku, Tokyo (JP); Masahiko Ota, Ota-ku, Tokyo (JP)

(21) Appl. No.: 18/877,809

(22) PCT Filed: Jun. 19, 2023
(86) PCT No.: PCT/JP2023/022673

§ 371 Date: Dec. 20, 2024

(30) Foreign Application Priority Data
Jun. 21, 2022 (JP) 2022-099867

(51) Int. Cl. B60W 50/06; B60W 50/00; G06N 20/00

(52) U.S. Cl. CPC B60W 50/06; B60W 50/0097; G06N 20/00; B60W 2552/35

(57) ABSTRACT

There is provided a predicting device 10 having: an acquiring section 101 acquiring input data that is based on data of reflected waves of microwaves irradiated toward a paved road while traveling on the road; a predicting section 102 carrying out machine learning by using, as teacher data, the input data and information of places exhibiting a characteristic of having a possibility that damage may arise at the road, and predicting a place where there is a possibility that damage may arise at the road from the input data and by using a trained model that, when the input data is inputted thereto, outputs a place where there is a possibility that damage may arise at the road; and a presenting section 103 presenting results of prediction by the predicting section 102.

### TECHNICAL FIELD

The present invention relates to a damage place predicting device, a damage place predicting method, a damage place predicting program, and a trained model generating method.

### BACKGROUND ART

The pavement of roads on which vehicles travel daily becomes damaged due to the application of loads received from vehicles, temperature changes at locations where roads are built, and effects of rainwater on roads. Cracks and potholes are specific examples of damage to pavement. Potholes are round holes or cavities that arise due to the surface layer of the pavement peeling-off. In order to rapidly learn of such road damage and manage the maintenance of roads, work for grasping the conditions of the road surfaces of roads is carried out routinely. Patent Document 1 discloses a trained model generating method and road surface condition determining device whose object is to be able to determine road surface conditions inexpensively and accurately.

### PRIOR ART DOCUMENTS

### Patent Documents

Patent Document 1: Japanese Patent Application Laid-Open (JP-A) No. 2021-169705

### SUMMARY OF INVENTION

### Technical Problem

The technique disclosed in Patent Document 1 can determine the absence/presence of road attributes such as potholes, but does not predict places where it seems that damage to the pavement may arise from now on.

The present disclosure was made in view of the above-described points, and an object thereof is to provide a damage place predicting device, a damage place predicting method, a damage place predicting program, and a trained model generating method that can predict a place where it seems that damage to pavement may arise.

### Solution to Problem

A damage place predicting device relating to a first aspect of the present invention includes: an acquiring section acquiring input data that is based on data of reflected waves of microwaves irradiated toward a paved road while traveling on the road; a predicting section carrying out machine learning by using, as teacher data, the input data and information of places exhibiting a characteristic of having a possibility that damage to pavement may arise at the road, and predicting a place where there is a possibility that damage to pavement may arise at the road from the input data and by using a trained model that, when the input data is inputted thereto, outputs a place where there is a possibility that damage may arise at the road; and a presenting section presenting results of prediction by the predicting section.

In a damage place predicting device relating to a second aspect of the present invention, in the damage place predicting device relating to the first aspect, the predicting section predicts the place at a region where a wheel contacts the road.

In a damage place predicting device relating to a third aspect of the present invention, in the damage place predicting device relating to the first aspect or the second aspect, the predicting section predicts the place by using at least any of plural data obtained by slicing the input data along a direction of traveling on the road, plural data obtained by slicing the input data along a direction laterally traversing the road, and plural data obtained by slicing along a depth direction of the road.

In a damage place predicting device relating to a fourth aspect of the present invention, in the damage place predicting device relating to the third aspect, the predicting section predicts the place by combining first results, which are results of prediction using plural data obtained by slicing the input data along the depth direction of the road, and second results, which are results of prediction using plural data obtained by slicing the input data along the direction of laterally traversing the road.

In a damage place predicting device relating to a fifth aspect of the present invention, in the damage place predicting device relating to the fourth aspect, the predicting section predicts the place from a logical product of the first results and the second results.

In a damage place predicting device relating to a sixth aspect of the present invention, in the damage place predicting device relating to the fourth aspect, the predicting section predicts the place by filtering by a joint probability of the first results and the second results.

In a damage place predicting method relating to a seventh aspect of the present invention, a processor executes processings of: acquiring input data that is based on data of reflected waves of microwaves irradiated toward a paved road while traveling on the road; carrying out machine learning by using, as teacher data, the input data and information of places exhibiting a characteristic of having a possibility that damage to pavement may arise at the road, and predicting a place where there is a possibility that damage may arise at the road from the input data and by using a trained model that, when the input data is inputted thereto, outputs a place where there is a possibility that damage to the pavement may arise at the road; and presenting results of the predicting.

A damage place predicting program relating to an eighth aspect of the present invention causes a processor to execute processings of: acquiring input data that is based on data of reflected waves of microwaves irradiated toward a paved road while traveling on the road; carrying out machine learning by using, as teacher data, the input data and information of places exhibiting a characteristic of having a possibility that damage to pavement may arise at the road, and predicting a place where there is a possibility that damage to pavement may arise at the road from the input data and by using a trained model that, when the input data is inputted thereto, outputs a place where there is a possibility that damage to the pavement may arise at the road; and presenting results of the predicting.

In a trained model generating method relating to a ninth aspect of the present invention, a processor: carries out machine learning by using, as teacher data, input data, which is based on data of reflected waves of microwaves irradiated toward a paved road while traveling on the road, and information of places exhibiting a characteristic of having a possibility that damage to pavement may arise at the road; and, by the machine learning, generates a trained model that, when the input data is inputted thereto, outputs a place where there is a possibility that damage to the pavement may arise at the road.

### Advantageous Effects of Invention

In accordance with the present disclosure, there can be provided a damage place predicting device, a damage place predicting method, a damage place predicting program, and a trained model generating method that can predict a place where it seems that damage to pavement may arise.

### BRIEF DESCRIPTION OF DRAWINGS

FIG. 1 is a drawing illustrating the schematic structure of a damage place predicting system that includes a predicting device relating to a present embodiment.

FIG. 2 is a drawing for explaining detection of a reflection response waveform.

FIG. 3 is a drawing illustrating situations of reflection of electromagnetic waves irradiated from an electromagnetic wave device.

FIG. 4 is a block diagram illustrating hardware structures of the predicting device.

FIG. 5 is a block diagram illustrating an example of functional structures of the predicting device.

FIG. 6 is a block diagram illustrating hardware structures of a training device.

FIG. 7 is a block diagram illustrating an example of functional structures of the training device.

FIG. 8 is a flowchart illustrating the flow of predicting processing by the predicting device.

FIG. 9 is a drawing illustrating examples of images based on Y volume data and Z volume data.

FIG. 10 is a drawing for explaining Y volume data and Z volume data.

FIG. 11 is a drawing illustrating examples of presentation of results predicted by the predicting device.

### DESCRIPTION OF EMBODIMENTS

Examples of embodiments of the present disclosure are described hereinafter with reference to the drawings. Note that structural elements and portions that are the same or equivalent are denoted by the same reference numerals in the respective drawings. Further, the dimensional proportions in the drawings are exaggerated for convenience of explanation, and there are cases in which they differ from actual proportions.

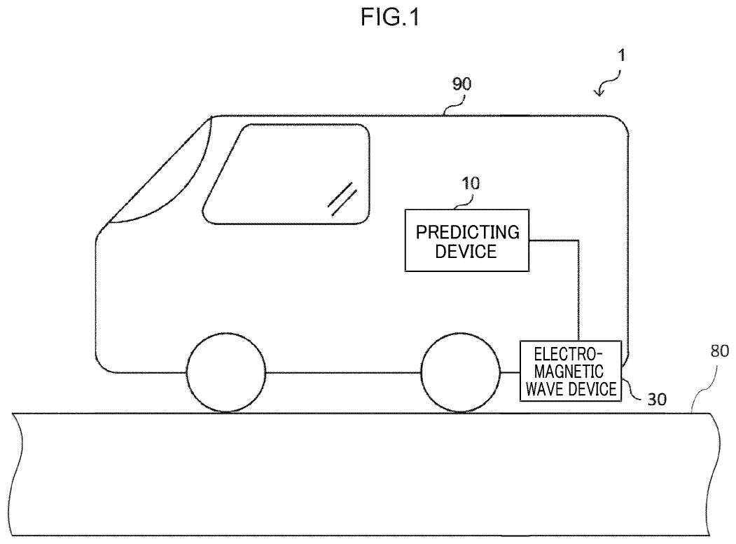

FIG. 1 is a drawing illustrating the schematic structure of a damage place predicting system that includes a predicting device relating to a present embodiment. As illustrated in FIG. 1, damage place predicting system 1 relating to the present embodiment is installed in a vehicle 90.

The damage place predicting system 1 is a system that predicts a place where it seems that damage to the pavement of a road 80, which is paved by asphalt or the like, may arise, e.g., a place where a pothole may form. The damage place predicting system 1 is configured to include a predicting device 10 and an electromagnetic wave device 30. The predicting device 10 is a device for predicting a place where it seems that damage to the pavement of the road 80 may arise.

The electromagnetic wave device 30 has plural electromagnetic wave irradiating portions and receiving portions that are provided in a line. The electromagnetic wave device 30 is provided, for example, at the lower portion of the rear of the vehicle 90, such that the traveling direction of the vehicle 90 is the bridge axis direction, and the line direction of the electromagnetic wave device 30 is the direction orthogonal to the bridge axis direction. The electromagnetic wave irradiating portions irradiate electromagnetic waves such as microwaves toward the road 80. The receiving portions receive waves that has been reflected by respective portions of the inner portion of the pavement of the road 80.

A known electromagnetic wave radar system can be used without any particular limitations as the electromagnetic wave irradiating portions. However, from the standpoints of work efficiency and accuracy, it is preferable to use a radar system in which a large number of transmitting/receiving sensors are lined-up. Further, from the standpoint of work efficiency, it is preferable that the transmitting/receiving sensors use an antenna array that is antennas in the form of an array.

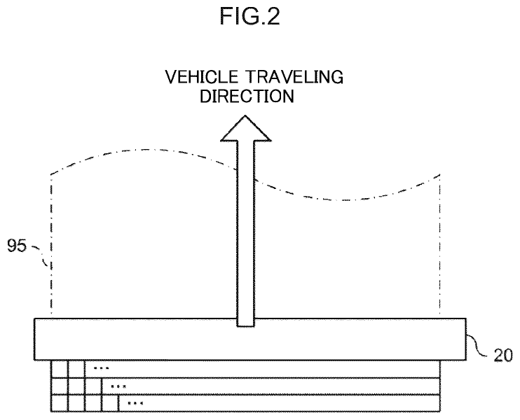

As illustrated in FIG. 2, while scanning an evaluation subject range 95 of the road 80 in the vehicle traveling direction, the electromagnetic wave device 30 irradiates electromagnetic waves in the internal (depth) direction of the road 80 from the surface, and receives the reflected waves thereof. The electromagnetic wave device 30 thereby detects the reflected wave intensities, which correspond to the depths, of the respective grids of the evaluation subject range 95. One grid is, for example 1 cm×1 cm, and the width of one line can be made to be 2.0 m. In this case, reflection response waveforms of 200 grids are detected per line.

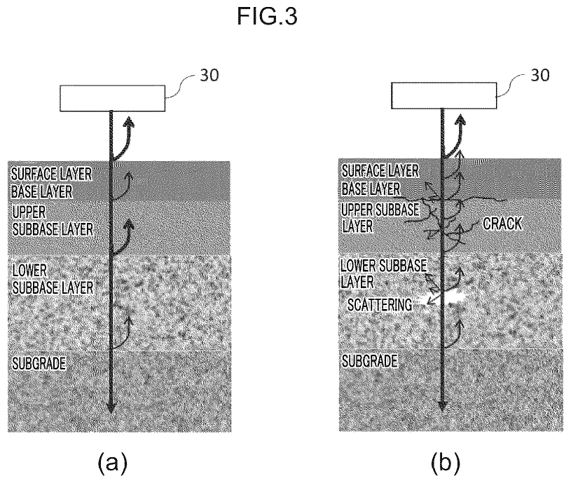

The electromagnetic waves irradiated from the electromagnetic wave device 30 are reflected at the borders of the layers of the road 80. However, if an abnormality is detected at the border of layers of the road 80 or within a layer, the electromagnetic waves irradiated from the electromagnetic wave device 30 are reflected in a pattern that is different from a normal state. FIG. 3 is a drawing illustrating situations of reflection of electromagnetic waves irradiated from the electromagnetic wave device 30. The road 80 is paved with asphalt, and, in a case in which the pavement is formed from a surface layer, a base layer, an upper subbase layer and a lower subbase layer, the electromagnetic waves are reflected as illustrated in (a) of FIG. 3 if the respective layers are in normal states. On the other hand, if a crack has formed at a boundary between layers, or if a cavity has formed at the interior of a layer, some of the electromagnetic waves are irregularly reflected as illustrated in (b) of FIG. 3. At a place where the electromagnetic waves are irregularly reflected as in (b) of FIG. 3, the surface layer portion appears to be normal at a glance, but abnormalities have arisen at the layers beneath. Therefore, this is a place at which it is thought that the pavement has already been damaged, or that damage to the pavement will arise from now on.

At the time when the predicting device 10 predicts a place where it seems that damage to the pavement of the road 80 may arise, the predicting device 10 uses data of the reflected wave from the road 80, of the electromagnetic waves that the electromagnetic wave device 30 irradiated toward the road 80. The data of the reflected waves can be subjected to three-dimensional processing and used as image data. Further, at the time when the predicting device 10 predicts a place where it seems that damage to the pavement of the road 80 may arise, the predicting device 10 uses a trained model generated by training by a machine learning technique that uses, as teacher data, data of reflected waves of electromagnetic waves and information of places of damage to pavement of roads. Due to the predicting device 10 inputting information of the waves reflected from the road 80 to the trained model, a place where it seems that damage to the pavement of the road 80 may arise is outputted from the trained model, and the predicting device 10 can thereby predict a place where it seems that damage to the pavement of the road 80 may arise.

The electromagnetic wave device 30 outputs the acquired information of the reflection response waveforms (reflected wave intensities corresponding to depths) of the respective grids to the predicting device 10. Note that the electromagnetic wave device 30 is not limited to being in a form of being mounted to the vehicle 90, and may be in another form such as a form of being held by a worker or the form of a cart. Further, the predicting device 10 also is not limited to being in a form of being installed in the vehicle 90, and may be in another form such as a form of being held by a worker.

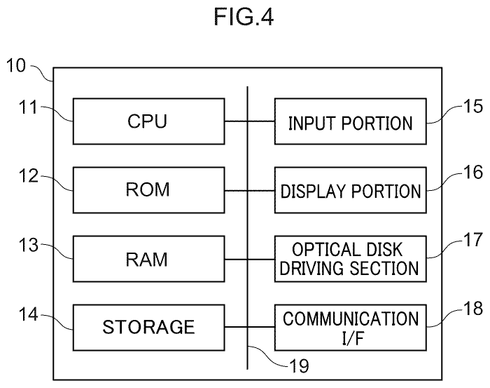

FIG. 4 is a block diagram illustrating hardware structures of the predicting device.

As illustrated in FIG. 4, the predicting device 10 has the respective structures of a CPU (Central Processing Unit) 11, a ROM (Read Only Memory) 12, a RAM (Random Access Memory) 13, a storage 14, an input portion 15, a display portion 16, an optical disk driving section 17, and a communication interface (communication I/F) 18. These respective structures are connected so as to be able to communicate with one another via bus 19.

The CPU 11 is a central computing processing unit, and executes various programs and controls respective sections. Namely, the CPU 11 reads-out programs from the ROM 12 or the storage 14, and executes the programs by using the RAM 13 as a workspace. In accordance with the programs recorded in the ROM 12 or the storage 14, the CPU 11 carries out control of the above-described respective structures, and various types of computing processings. In the present embodiment, a predicting program (damage place predicting program) for predicting a place where it seems that damage to the pavement of the road 80 may arise is stored in the ROM 12 or the storage 14.

The ROM 12 stores various programs and various data. The RAM 13 temporarily stores programs and data as a workspace. The storage 14 is configured by an HDD (Hard Disk Drive) or an SSD (Solid State Drive), and stores various programs, including the operating system, and various data.

The input portion 15 includes a pointing device such as a mouse, and a keyboard, and is used in order to carry out various types of input. The display portion 16 is, for example, a liquid crystal display, and displays various information. By employing a touch panel type display therefor, the display portion 16 may also function as the input portion 15.

The optical disk driving section 17 carries out reading of data stored on any of various types of recording media such as a CD-ROM (Compact Disc Read Only Memory) or a Blu-ray disc, and writing of data to recording media, and the like.

The communication interface 18 is an interface for communication with other devices, and standards such as, for example, Ethernet®, FDDI, or Wi-Fi® are used thereat.

At the time of executing the aforementioned predicting program, the predicting device 10 realizes various functions by using the above-described hardware resources. The functional structures realized by the predicting device 10 are described.

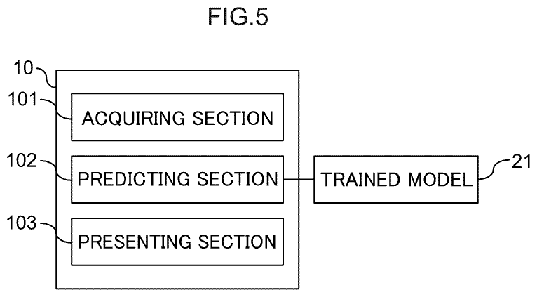

FIG. 5 is a block diagram illustrating an example of the functional structures of the predicting device 10.

As illustrated in FIG. 5, the predicting device 10 has, as the functional structures thereof, an acquiring section 101, a predicting section 102 and a presenting section 103.

These respective functional structures are realized by the CPU 11 reading-out and executing the predicting program that is stored in the ROM 12 or the storage 14.

The acquiring section 101 acquires data of the reflected waves of the electromagnetic waves that the electromagnetic wave device 30 irradiated toward the road 80. The acquiring section 101 may acquire image data that is generated by the data of the reflected waves of the electromagnetic waves being subjected to three-dimensional processing.

The predicting section 102 predicts a place where it seems that damage to the pavement of the road 80 may arise, by inputting data of the reflected waves acquired by the acquiring section 101 to a trained model 21 that has been trained in advance, and having prediction results outputted from the trained model 21. The predicting section 102 may carry out three-dimensional processing on the data of the reflected waves of the electromagnetic waves and convert the data into image data, and may input the image data to the trained model 21. Or, in a case in which the acquiring section 101 acquires image data that is generated due to the data of the reflected waves of the electromagnetic waves being subjected to three-dimensional processing, the predicting section 102 may input the image data acquired by the acquiring section 101 to the trained model 21.

The trained model 21 that the predicting section 102 uses in prediction is a model that has been trained in advance such that, when image data, which has been generated from data of reflected waves of electromagnetic waves that were irradiated toward a road, is inputted thereto, the trained model 21 extracts and outputs a place where there is the possibility that damage may arise at that road. For example, the trained model 21 is a model that has been trained in advance so as to output, as a place at which there is the possibility that damage will occur, a place where the probability that damage will occur exceeds a predetermined threshold value.

Note that the predicting section 102 may predict a place where damage to the pavement of the road 80 may occur, for the entire region where electromagnetic waves are irradiated onto the road 80, but may predict a place where damage to the road 80 may occur at regions where the wheels of the vehicle contact the road. Regions where the wheels of the vehicle contact the road 80 mean regions where mainly the wheels contact the road 80 due to normal traveling of the vehicle, and mean regions where ruts may form after many vehicles have traveled thereon.

In a case in which the predicting section 102 carries out prediction by inputting image data to the trained model 21, the predicting section 102 may input image data, which is obtained by slicing a three-dimensional image in a predetermined direction, to the trained model 21 and cause the trained model 21 to carry out prediction. The traveling direction of the vehicle 90 on the road 80 is considered to be the X direction, the horizontal direction that is orthogonal to the X direction, i.e., the direction laterally traversing the road 80, is considered to be the Y direction, and the depth direction of the road 80 is considered to be the Z direction. An image that has been sliced in the Y direction is called a Y-sliced image, and a set of plural Y-sliced images is called Y volume data. Further, an image that has been sliced in the Z direction is called a Z-sliced image, and a set of plural Z-sliced images is called Z volume data.

In this case, the predicting section 102 may input Y volume data and Z volume data to the trained model 21, and filter the results extracted by the trained model 21. As the filtering processing, the predicting section 102 may carry out filtering in accordance with the logical product of the extracted places of both. Or, as the filtering processing, the predicting section may carry out filtering processing in accordance with the joint probability. The joint probability is determined as (likelihood of Z volume data×likelihood of Y volume data)^{1/2}. By carrying out filtering processing, the predicting section 102 can aim for a reduction in the number of places that are extracted unnecessarily due to erroneous detection or the like.

Note that the trained model 21 may be a model that is trained by further using, in addition to the Y volume data and the Z volume data, also X volume data that is a set of X-sliced images that are images that have been sliced in the X direction.

In the example of FIG. 5, the trained model 21 exists outside of the predicting device 10, but the trained model 21 may exist within the predicting device 10.

The presenting section 103 presents, on the display portion 16, information of a place where it seems that damage to the pavement of the road 80 may arise, that has been predicted by the predicting section 102.

Due to the predicting section 102 having such structures, the predicting device 10 can, on the basis of data of the reflected waves of the electromagnetic waves irradiated by the electromagnetic wave device 30 toward the road 80, predict information of a place where it seems that damage to the pavement of the road 80 may arise and present the results of prediction.

The training device, which trains the trained model that the predicting device 10 uses in prediction and that generates a trained model, is described next.

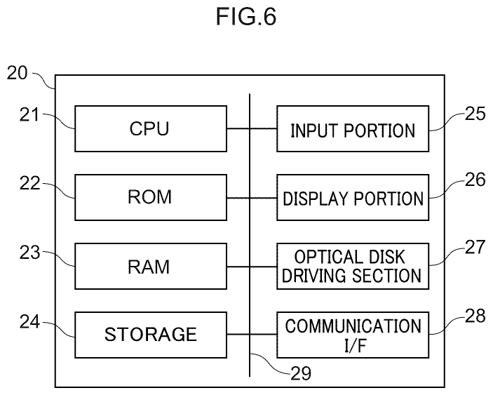

FIG. 6 is a block diagram illustrating hardware structures of the training device.

As illustrated in FIG. 6, a training device 20 has the respective structures of a CPU 21, a ROM 22, a RAM 23, a storage 24, an input portion 25, a display portion 26, an optical disk driving section 27, and a communication interface (communication I/F) 28. These respective structures are connected so as to be able to communicate with one another via bus 29.

The CPU 21 is a central computing processing unit, and executes various programs and controls respective sections. Namely, the CPU 21 reads out programs from the ROM 22 or the storage 24, and executes the programs by using the RAM 23 as a workspace. In accordance with the programs recorded in the ROM 22 or the storage 24, the CPU 21 carries out control of the above-described respective structures, and various types of computing processings. In the present embodiment, a training program, which generates a trained model by training a model for predicting a place where damage to the pavement of the road 80 may arise, is stored in the ROM 22 or the storage 24.

The ROM 22 stores various programs and various data. The RAM 23 temporarily stores programs and data as a workspace. The storage 24 is configured by an HDD or an SSD, and stores various programs, including the operating system, and various data.

The input portion 25 includes a pointing device such as a mouse, and a keyboard, and is used in order to carry out various types of input. The display portion 26 is, for example, a liquid crystal display, and displays various information. By employing a touch panel type display therefor, the display portion 26 may also function as the input portion 25.

The optical disk driving section 27 carries out reading of data stored on any of various types of recording media such as a CD-ROM or a Blu-ray disc, and writing of data to recording media, and the like.

The communication interface 28 is an interface for communication with other devices, and standards such as, for example, Ethernet®, FDDI, or Wi-Fi® are used thereat.

At the time of executing the aforementioned training program, the training device 20 realizes various functions by using the above-described hardware resources. The functional structures realized by the training device 20 are described.

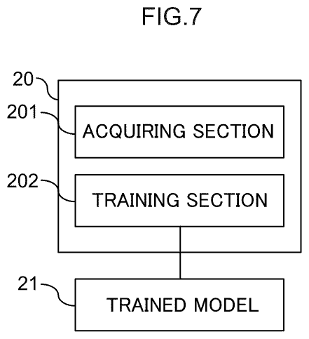

FIG. 7 is a block diagram illustrating an example of the functional structures of the training device 20.

As illustrated in FIG. 7, the training device 20 has, as the functional structures thereof, an acquiring section 201 and a training section 202. These respective functional structures are realized by the CPU 21 reading-out and executing the training program that is stored in the ROM 22 or the storage 24.

The acquiring section 201 acquires teacher data for training a model and generating the trained model 21. The teacher data for generating the trained model 21 includes sets of three-dimensional image data, which is generated on the basis of data of reflected waves of electromagnetic waves that the electromagnetic wave device 30 irradiated toward the road 80, and information of places where damage has arisen at the road 80.

By using the teacher data acquired by the acquiring section 201, the training section 202 trains a model and generates the trained model 21. The training section 202 generates the trained model 21 by carrying out training in the direction in which the error between a place, which has been predicted by the trained model 21 and exhibits the characteristic that there is the possibility that damage may arise at the road 80, and a place where damage has actually arisen at the road 80, decreases. The number of teacher data for training the model is not limited to a predetermined number, but is preferably a number of an extent such that overfitting does not arise.

The algorithm for training the model by the training section 202 is not limited to a specific algorithm. Examples of models or algorithms that are used in supervised learning as in the present embodiment are regression analysis, decision tree, support vector machine (SVM), neural networks, ensemble learning, and random forest. Further, supervised learning may be carried out for each class, after classification into classes has been carried out in advance. The classification into classes at this time may be supervised or unsupervised.

In the example of FIG. 7, the trained model 21 exists outside of the training device 20, but the trained model 21 may exist within the training device 20.

At the time of generating the trained model 21, the training section 202 uses at least any of the X volume data, the Y volume data and the Z volume data as the teacher data. The training section 202 may train the model by using only one of the volume data. However, by training the model by using plural volume data, the accuracy of prediction can be improved as compared with a case of training by using only one volume data.

By using the trained model 21 that has been generated by the training device 20, and on the basis of data of the reflected waves of the electromagnetic waves irradiated by the electromagnetic wave device 30 toward the road 80, the predicting device 10 can predict information of a place where it seems that damage to the pavement of the road 80 may arise, and can present the results of prediction.

Operation of the predicting device 10 is described next.

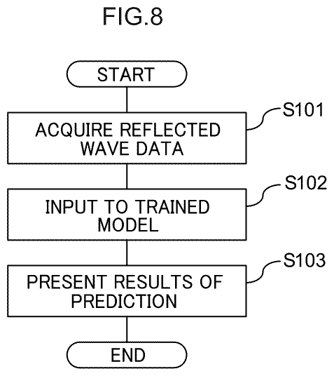

FIG. 8 is a flowchart illustrating the flow of predicting processing by the predicting device 10. The predicting processing is carried out due to the CPU 11 reading out the predicting program from the ROM 12 or the storage 14, and expanding and executing the program in the RAM 13.

In step S101, the CPU 11 acquires data of the reflected waves of electromagnetic waves irradiated by the electromagnetic wave device 30 toward the road 80.

When the CPU 11 acquires the data of the reflected waves, next, in step S102, the CPU 11 inputs the data of the reflected waves into a trained model, and predicts a place where it seems that damage of the pavement of the road 80 may arise.

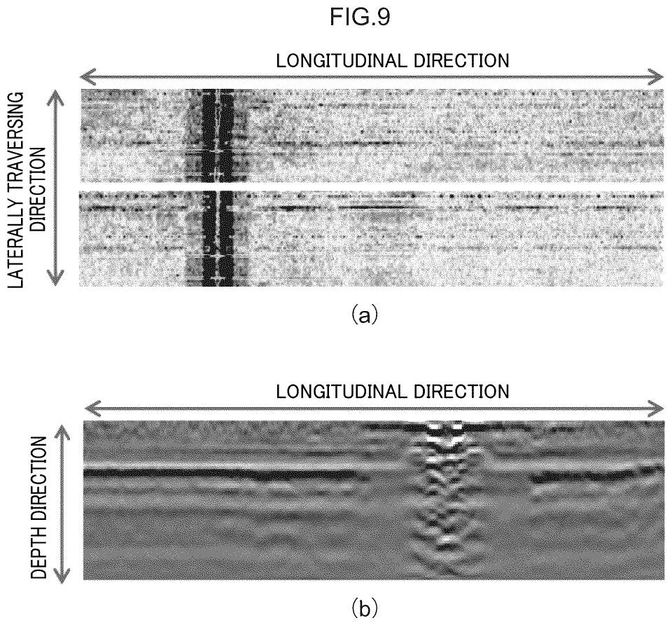

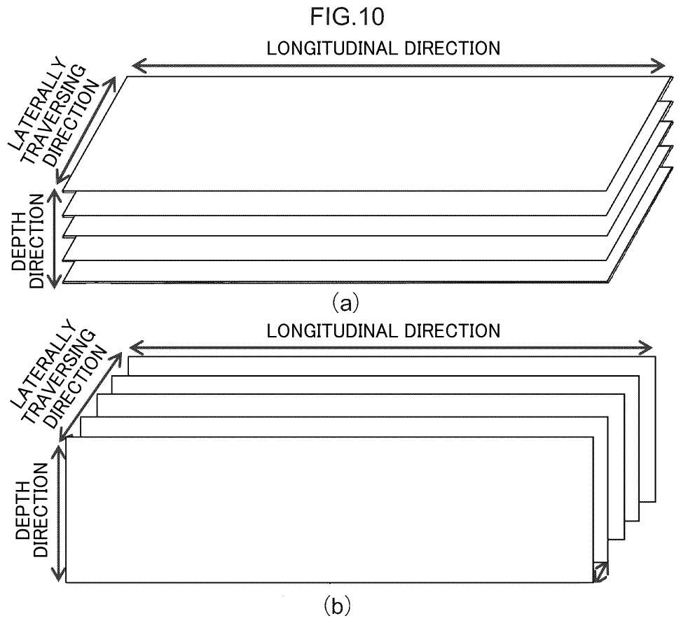

At the time of predicting a place where it seems that damage to the pavement of the road 80 may arise, the CPU 11 may input Y volume data and Z volume data into the trained model 21. FIG. 9 is a drawing illustrating examples of images based on Y volume data and Z volume data. The (a) in FIG. 9 is an example of a Z-sliced image that is based on the Z volume data, and the (b) in FIG. 9 is an example of a Y-sliced image that is based on the Y volume data. Further, FIG. 10 is a drawing illustrating examples of Y volume data and Z volume data obtained by slicing a three-dimensional image. The (a) in FIG. 10 is an example of Z volume data formed from plural Z-sliced images, and the (b) in FIG. 10 is an example of Y volume data formed from plural Y-sliced images.

The CPU 11 may input Y volume data and Z volume data to the trained model 21, and may filter the results that the trained model 21 extracts. As the filtering processing, the CPU 11 may carry out filtering in accordance with the logical product of extracted places of both. Further, as the filtering processing, the CPU 11 may carry out filtering in accordance with the joint probability. The joint probability is determined as (likelihood of Z volume data×likelihood of Y volume data)^{1/2}. By carrying out filtering processing, the CPU 11 can aim for a reduction in the number of places that are extracted unnecessarily due to erroneous detection or the like.

When information of a place where it seems that damage to the pavement of the road 80 may arise is predicted, next, in step S103, the CPU 11 presents the results of prediction.

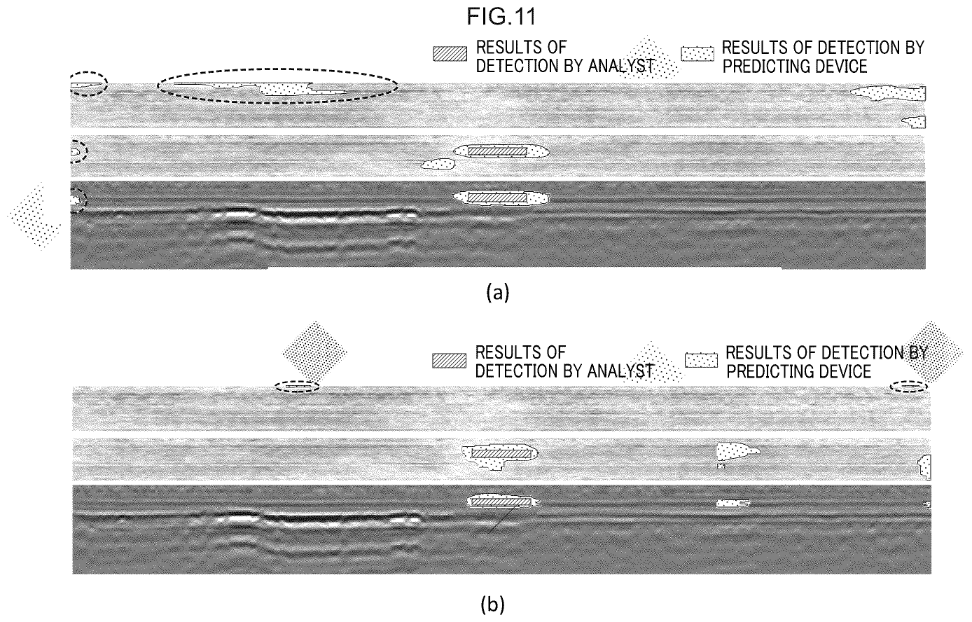

FIG. 11 is a drawing illustrating examples of presenting the results of prediction by the predicting device 10. The (a) in FIG. 11 is an example of results of inputting Y volume data to the trained model 21, and the (b) in FIG. 11 is an example of results of inputting Z volume data to the trained model 21. As illustrated in FIG. 11, by inputting image data, which is generated on the basis of the data of the reflected waves of the electromagnetic waves, to the trained model 21, the predicting device 10 can extract a place that is similar to a place where an analyst has actually detected that damage to the pavement of the road 80 has arisen.

By executing such processing, the predicting device 10 can, on the basis of data of the reflected waves of the electromagnetic waves irradiated by the electromagnetic wave device 30 toward the road 80, predict information of a place where it seems that damage to the pavement of the road 80 may arise, and present the results of prediction.

The predicting device 10 and the training device 20 have the CPUs 11, 21 as hardware structures, but may further have GPUs (Graphics Processing Units). Due to the predicting device 10 and the training device 20 having GPUs in addition to the CPUs 11, 21, parallel processing can be carried out for the predicting processing and the training processing at the CPUs 11, 21 and the GPUs. Due to the predicting device 10 and the training device 20 carrying out parallel processing for the predicting processing and the training processing at the CPUs 11, 21 and the GPUs, an improvement in the processing speed of detecting places of damage at the pavement, and an improvement in the processing speed of training the trained model, can be expected.

The training device 20 may additionally train the trained model 21 by using results of prediction that the predicting device 10 outputted by using the trained model 21. For example,, if a place showing the characteristics of the possibility that damage to the pavement may arise, cannot be detected by the predicting section 102, the training device 20 may improve the accuracy of detection by carrying out additional training by using, as input, data of the place that could not be detected. An improvement in the accuracy of the trained model 21 becomes possible by having the training device 20 additionally trained with the trained model 21.

Further, it can be thought that, at roads of respective geographical regions, the characteristic that there is the possibility that damage to the pavement may arise varies due to differences in road structures, meteorological environments, traffic amounts and other environmental conditions. Accordingly, the training device 20 may optimize the predicting of damage to pavement by preparing the trained model 21 for each geographical region or route. Due to the trained model 21 being prepared for each geographical region or route, the predicting device 10 can accurately detect a place where there is the possibility that damage to pavement may arise, as compared with a case of using the trained model 21 that does not take differences per geographical region or route into consideration.

Note that the training processing and the predicting processing, which are executed by CPUs reading-in software (programs) in the above-described embodiment, may be executed by any of various types of processors other than CPUs. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits).

Further, the training processing and the predicting processing may be executed by one of these various types of processors, or may be executed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

Further, the above embodiment describes a form in which the programs of the training processing and the predicting processing are stored in advance (are installed) in the ROMs or the storages, but the present disclosure is not limited to this. The programs may be provided in a form of being recorded on a non-transitory recording medium such as a CD-ROM (Compact Disk Read Only Memory), a DVD-ROM (Digital Versatile Disk Read Only Memory), or a USB (Universal Serial Bus) memory. Further, the programs may be in a form of being downloaded over a network from an external device.

The disclosure of Japanese Patent Application No. 2022-099867 filed on Jun. 21, 2022, is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A damage place predicting device, comprising:
at least one processor, the processor being configured to:
acquire input data that is based on data for reflected waves from microwaves irradiated toward a paved road while traveling on the road;
carry out machine learning by using, as training data, the input data and information regarding places exhibiting a characteristic of having a possibility that damage to pavement may arise at the road, and predict a place at which there is a possibility that damage to pavement may arise at the road from the input data and by using a trained model that, when the input data is input thereto, outputs a place at which there is a possibility that damage to pavement may arise at the road; and
present results of the prediction.

2. The damage place predicting device of claim 1, wherein the processor is configured to predict the place in a region at which a wheel contacts the road.

3. The damage place predicting device of claim 1, wherein the processor is configured to predict the place by using at least any of a plurality of data obtained by slicing the input data along a direction of travel on the road, a plurality of data obtained by slicing the input data along a direction laterally traversing the road, and a plurality of data obtained by slicing along a depth direction of the road.

4. The damage place predicting device of claim 3, wherein the processor is configured to predict the place by combining first results, which are results of prediction using a plurality of data obtained by slicing the input data along the depth direction of the road, and second results, which are results of prediction using a plurality of data obtained by slicing the input data along the direction laterally traversing the road.

5. The damage place predicting device of claim 4, wherein the processor is configured to predict the place from a logical product of the first results and the second results.

6. The damage place predicting device of claim 4, wherein the processor is configured to predict the place by filtering by a joint probability of the first results and the second results.

7. A damage place predicting method, in which a processor executes processing comprising:
acquiring input data that is based on data for reflected waves from microwaves irradiated toward a paved road while traveling on the road;
carrying out machine learning by using, as training data, the input data and information regarding places exhibiting a characteristic of having a possibility that damage to pavement may arise at the road, and predicting a place at which there is a possibility that damage to pavement may arise at the road from the input data and by using a trained model that, when the input data is input thereto, outputs a place at which there is a possibility that damage to pavement may arise at the road; and
presenting results of the predicting.

8. A non-transitory recording medium storing a program that is executable by a computer to perform a processing, the processing comprising:
acquiring input data that is based on data for reflected waves from microwaves irradiated toward a paved road while traveling on the road;
carrying out machine learning by using, as training data, the input data and information regarding places exhibiting a characteristic of having a possibility that damage to pavement may arise at the road, and predicting a place at which there is a possibility that damage to pavement may arise at the road from the input data and by using a trained model that, when the input data is input thereto, outputs a place at which there is a possibility that damage to pavement may arise at the road; and
presenting results of the predicting.

9. A trained model generation method, in which a processor:
carries out machine learning by using, as teacher data, input data, which is based on data for reflected waves from microwaves irradiated toward a paved road while traveling on the road, and information regarding places exhibiting a characteristic of having a possibility that damage to pavement may arise at the road; and
by the machine learning, generates a trained model that, when the input data is input thereto, outputs a place at which there is a possibility that damage to pavement may arise at the road.
